(19) United States
(12) Patent Application Publication
(10) Pub. No.: US 2009/0093955 A1
(43) Pub. Date: Apr. 9, 2009

(54) Apparatus and Method of Compiling a Combined Picture and Showing It on a Display

(76) Inventor: Pieter Geelen, Amsterdam (NL)

Correspondence Address: HARNESS, DICKEY & PIERCE, P.L.C., P.O. BOX 8910, RESTON, VA, 20195, US

(21) Appl. No.: 11/885,671

(22) PCT Filed: Mar. 9, 2005
(86) PCT No.: PCT/NL05/00173

§ 371 Date: May 3, 2008

(51) Int. Cl. G01C 21/34

(52) U.S. Cl. 701/211

(57) ABSTRACT

In one embodiment of the present invention, a method of and system for receiving vector graphics data is disclosed relating to a map of a first geographic area corresponding to a portion of the earth surface and to show first data relating to the vector graphics data on a display, the method also including receiving raster graphics data relating to a second geographic area, and to show second data relating to the raster graphics data in an area on the display.

### FIELD OF THE INVENTION

The invention relates to a navigation system comprising a processor, a memory and a display, the processor being arranged to communicate with the memory and the display, the memory storing instructions and data to allow the processor to run a program, the processor being arranged to receive vector graphics data relating to a map of a first geographic area corresponding to a portion of the earth surface and to show first data relating to the vector graphics data on the display and to calculate a route based on received user instructions.

### BACKGROUND OF THE INVENTION

Such a navigation is, nowadays, widely used in many cars.

WO98/15912 describes a navigation system that shows bit-mapped data of the earth surface on a screen. The bit-mapped data is stored in a first memory device. However, the system also comprises a second memory device storing route information such as flight plan data that may be retrieved to be shown as an overlay on the bit-mapped data with corresponding features being aligned. The data as overled on the bitmapped data may be retrieved from bitmapped or vector graphics images. However, this prior art document does not disclose starting with showing a vector graphics image, the data of which also being used to calculate a route based on input received from a user. The bitmapped data that in WO-98/15912, essentially, fills the whole screen is unsuitable as a source for route calculations.

JP-A-4305684 discloses an automotive navigation system arranged for displaying a road map on a screen based on bitmap data stored in a database. The system has a receiver for receiving radio messages about blockades in certain road segments. The system decodes such messages and replaces pixels in the corresponding road section on the screen by a specific colour to indicate the blockade to the user. Thus, JP-A-4305684 is only concerned with replacing some bitmapped data by other bitmapped data.

Navigation devices based on GPS (Global Positioning System) are well known and are widely employed as in-car navigation systems. Such a GPS based navigation device relates to a computing device which in a functional connection to an external (or internal) GPS receiver is capable of determining its global position. Moreover, the computing device is capable of determining a route between start and destination addresses, which can be input by a user of the computing device. Typically, the computing device is enabled by software for computing a “best” route between the start and destination address locations from a map database. “Best” route is to be understood to be based on certain criteria. A “best” route does not necessarily need to be a fastest route. Such criteria may be stored or received from a user.

By using positional information derived from the GPS receiver, the computing device can determine at regular intervals its position (typically mounted on the dashboard of a vehicle) and can display the current position of the vehicle to the user via a display. Also, it can provide instructions how to navigate the determined route by appropriate navigation signals displayed on a screen and/or generated as audible signals from a speaker (e.g. ‘turn left in 100 m’). Graphics depicting the actions to be accomplished (e.g. a left arrow indicating a left turn ahead) can be displayed in a status bar and also be superimposed over the applicable junctions/turnings etc. in the roads shown in the map itself.

It is known to enable in-car navigation systems to allow the driver, whilst driving in a car along a route calculated by the navigation system, to initiate a route re-calculation. This is useful where the vehicle is faced with construction work or heavy congestion.

It is also known to enable a user to choose the kind of route calculation algorithm deployed by the navigation device, selecting for example from a ‘Normal’ mode and a ‘Fast’ mode (which calculates the route in the shortest time, but does not explore as many alternative routes as the Normal mode).

It is also known to allow a route to be calculated with user defined criteria; for example, the user may prefer a scenic route to be calculated by the device. The device software would then calculate various routes and weigh more favourably those that include along their route the highest number of points of interest (known as POIs) tagged as being for example of scenic beauty.

In general, the data used by the navigation system is stored on a CD-ROM or the like. Due to the limited memory size of such a memory device, the stored data relating to geography, like roads, lakes, cities, forests, etc., is vector graphics based, as is known to persons skilled in the art.

### SUMMARY OF THE INVENTION

It is an object of the invention to improve navigation systems of the prior art for users like pedestrians, and people driving cars or other means of transport. More specifically, it is an object to provide the user of the navigation system with improved information in a vector graphics based navigation system.

To that end, the invention provides a navigation system as defined at the outset, wherein the processor is also arranged to receive raster graphics data relating to a second geographic area, and to show second data relating to the raster graphics data on top of the first data in an area on the display which second data is aligned as to latitude and longitude with the first data on the display if latitude and longitude data to that effect is available.

Thus, the invention provides an easy way to show, possibly very detailed, raster graphics (or bitmap) based geographic data to a user of the navigation system, that is geographically aligned with the vector graphics based data on the display. The processor does all the scaling and possible necessary rotations to achieve alignment. The user can store many very detailed pictures or the like with a high pixel density, as desired, on e.g. a hard disk of his navigation system that has much more memory capacity than a CD-ROM that is usually used to store geographic data in vector graphics based form. The processor of the navigation system is used to integrate the bitmap based geographic data into the vector graphics based data. Thus, the processor can display very detailed geographic data on an area of interest to the user, e.g., including walking and cycling paths in a park which may not be available from the CD-ROM. Of course, the CD-ROM itself may also store some bitmap based data.

It is to be understood that “geographic data” is meant to include both two dimensional (2D) and three dimensional (3D) data.

In an embodiment, the invention relates to a method of receiving vector graphics data relating to a map of a first geographic area corresponding to a portion of the earth surface and to show first data relating to the vector graphics data on a display and to calculate a route based on received user instructions, the method also comprising receiving raster graphics data relating to a second geographic area, and to show second data relating to the raster graphics data in an area on the display, which second data is aligned as to latitude and longitude with the first data on the display if latitude and longitude data to that effect is available.

In a further embodiment, the invention relates to computer program product comprising instructions and data to allow a processor to run a predetermined program in accordance with such a method.

Finally, the invention relates to a data carrier comprising such a computer program product.

### BRIEF DESCRIPTION OF THE DRAWINGS

The invention will be explained below with reference to some drawings that are only intended to illustrate the invention but not to limit its scope. The scope is defined by the annexed claims and their technical equivalents.

FIG. 1 shows a schematic diagram of a system that can be used in the invention;

FIG. 2 shows an example of a display showing a compiled picture;

FIG. 3 shows an enlarged portion of the display of FIG. 2;

FIG. 4 shows a flow chart of an operation of the system in accordance with one embodiment of the invention;

FIG. 5 shows a compiled picture based on vector graphics data and two raster graphics data based images;

FIG. 6 shows a display with raster graphics data relating to different pictures, optionally with different pixel densities;

FIG. 7 shows a flow chart of an operation of the system in accordance with an embodiment of the invention where different pictures with overlapping areas are available.

### DESCRIPTION OF EMBODIMENTS

For the purpose of teaching of the invention, preferred embodiments of the method and devices of the invention are described below. It will be appreciated by the person skilled in the art that other alternative and equivalent embodiments of the invention can be conceived and reduced to practice without departing from the concept of the invention, the scope of the invention being limited only by the appended claims.

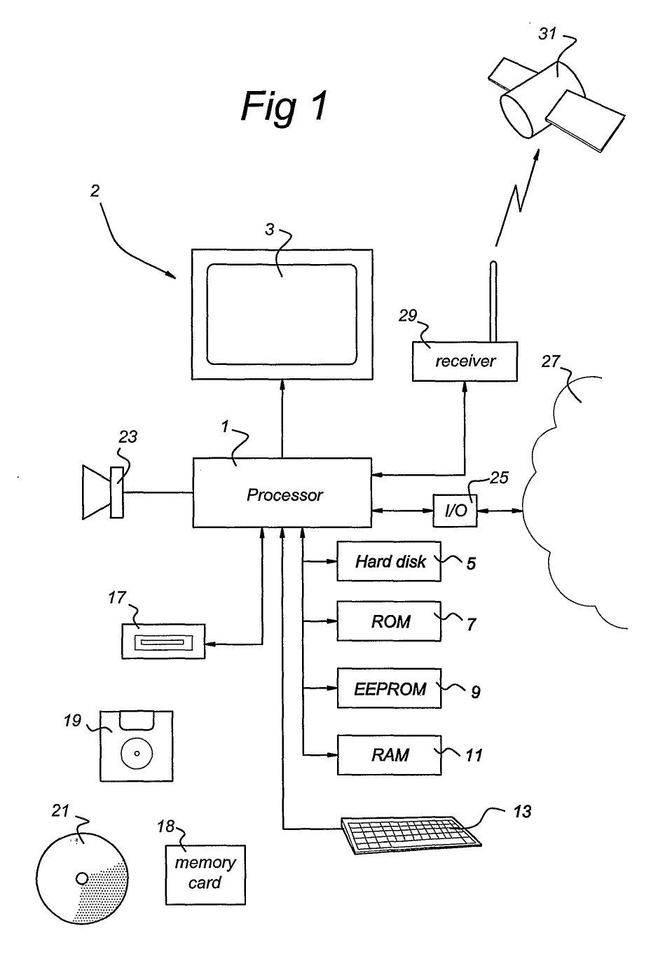

FIG. 1 shows schematically a navigation device.

Navigation device 2 is basically a computer system capable of route planning and navigation. The navigation device 2 comprises host processor 1 with peripherals. The host processor 1 is connected to one or more memory units 5, 7, 9, 11 which store instructions and data, one or more reading units 17 arranged to read, e.g., floppy disks 19, CD ROM's or DVD's 21, or non-volatile memory containing devices 18 such as flash-memory cards, memory sticks, etc. Moreover, the processor 1 is connected to input devices 13, and as output devices, a display 3 and an audio output like a speaker 23.

The input devices 13 may comprise an alphanumerical (or numerical) keyboard, a touch screen or touch pad, a pointer device (e.g., a cross-shaped cursor key), or a trackball. The touch screen may be arranged on the display 3 and may have a virtual keyboard as input device.

The memory units shown comprise RAM 11, (E)EPROM or non-volatile RAM 9, ROM 7, and a disk 5. However, it should be understood that there may be provided more and/or other memory units known to persons skilled in the art. Additionally, one or more of them may be physically located remote from the processor 1, if needed.

The processor 1 is shown as one box, however, it may comprise several processing units functioning in parallel or controlled by one main processor. The processing units may be located remotely from one another, as is known to persons skilled in the art, for example in a network topology.

The navigation device 2 is further connected to a location sensor 29. The location sensor 29 is shown as a GPS receiver for receiving GPS signals from satellites 31 but may, alternatively or additionally, be implemented as an accelerometer (or alternatively a gyroscope) for sensing changes of motion of the navigation device 2, or any other location sensors.

It is noted that the location sensor 29 may be in a fixed connection with the navigation device 2 or may be detachable from that (e.g., by some dock or connector).

The navigation device 2 may have an I/O connection device 25 for connection to a network. Since the navigation system is movable the I/O connection device 25 will, normally, provide for mobile communication.

The processor 1 of navigation device 2 is capable of executing software code that implements the method of the present invention. Instructions and data of such code will be stored in memory 5, 7, 9, 11. Instructions and data to that effect may be stored on a data carrier or downloaded e.g. via the Internet before being stored in memory 5-11.

In use, the memory 5-11 or an external CD-ROM 21 comprises a map database. In the map database map data, that relate to information on geographical locations, are stored. This will be explained below in more detail.

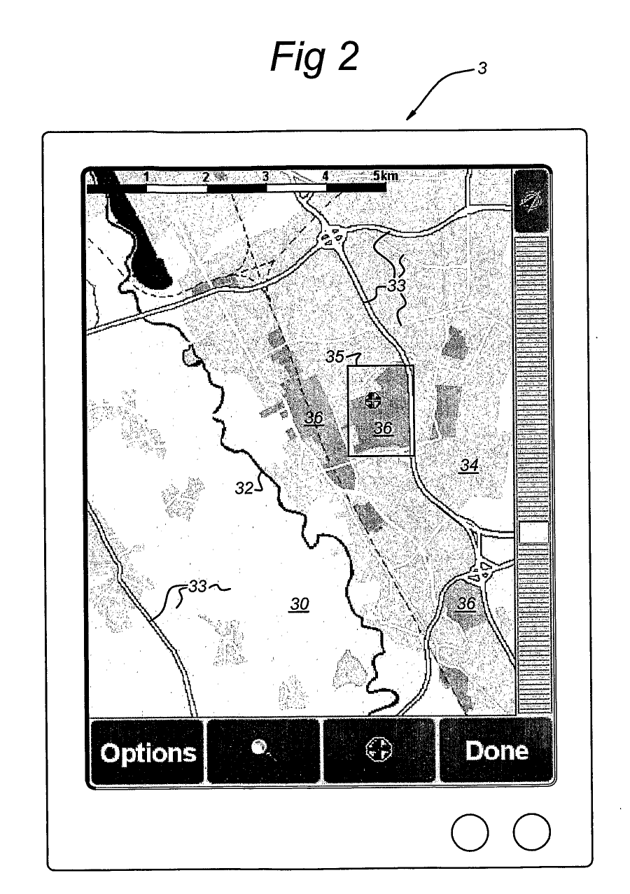

FIG. 2 shows the display 3 in use as a navigation supporting device. I.e., it shows roads 33 of a map. It also shows, e.g. by means of an arrow 37, a location of the navigation system on the map as determined by means of, e.g. the GPS receiver 29. Woods are indicated with 30, water with 32, buildings with 34, and areas with missing data with 36. The navigation system may be on board of a vehicle such as a car but may, alternatively, be part of a hand-held device, e.g., a personal digital assistant or a mobile telephone. The data relating to the map itself is stored, e.g., on a CD-ROM as is known to persons skilled in the art and retrieved from the CD-ROM by processor 1 in dependence on the position of the navigation system and, optionally, on a route calculated by the navigation system based on input data as to starting address (position) and destination address (position). The starting address (position) may be derived automatically from the GPS receiver 29 data. The geographic data is vector graphics data. This is all prior art and needs no further explanation.

A problem sometimes encountered by a user of the navigation system is that he or she wishes to see more (or other) geographically related data of a certain area 35 within the map shown on the display 3. Here, “geographically related data” is meant to refer to the earth surface including objects on the earth surface (houses, cars, boats, woods, etc.) but also to the earth surface with possible objects above that surface (airplanes, clouds, etc.) that may actually cover a whole area of interest. Such an area 35 may, e.g., relate to a centre of a city with a pedestrian area, a park or wood with paths only accessible for pedestrians or cyclist, an exhibition area, etc. The map then shown on the display 3 shows, e.g., some roads going to that area 35 but misses desired geographic data within the area 35. In accordance with the invention this is solved by integrating in the vector graphics data shown raster graphics data of the area 35, where the data in the area 35 is aligned as to latitude and longitude with the vector graphics data shown. The raster graphics data may be any kind of bit map data, like a Windows® bitmap, or a software object.

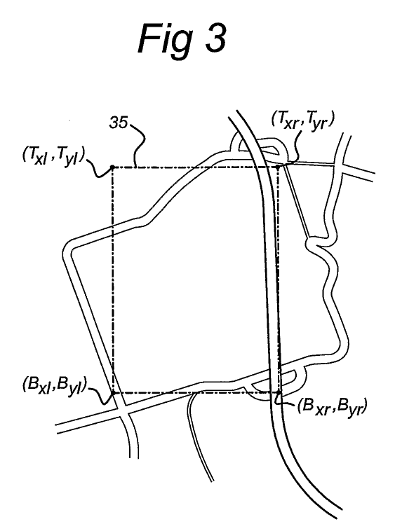

The raster graphics data may be based on a photo of the area 35, e.g., an aerial photo or a satellite photo. Such a photo may be stored in memory, e.g., the hard disk 5. The photo may have been downloaded from another device, e.g., directly from a satellite or via network 27 from a server (not shown) storing aerial/satellite photos in larger quantities. Such a server may, e.g., be accessible by a group of people who may only access the server for storing new images and/or reading images from the server if they have proper access rights, for which they, e.g., pay a subscription. Such a server will, basically, have components as shown in FIG. 1. The navigation system may be programmed to continuously download raster graphics data based pictures of areas surrounding the location of the navigation system itself. Height value data related to any of the pixels may be stored too. In order to further explain the invention, FIG. 3 shows area 35 on an enlarged scale.

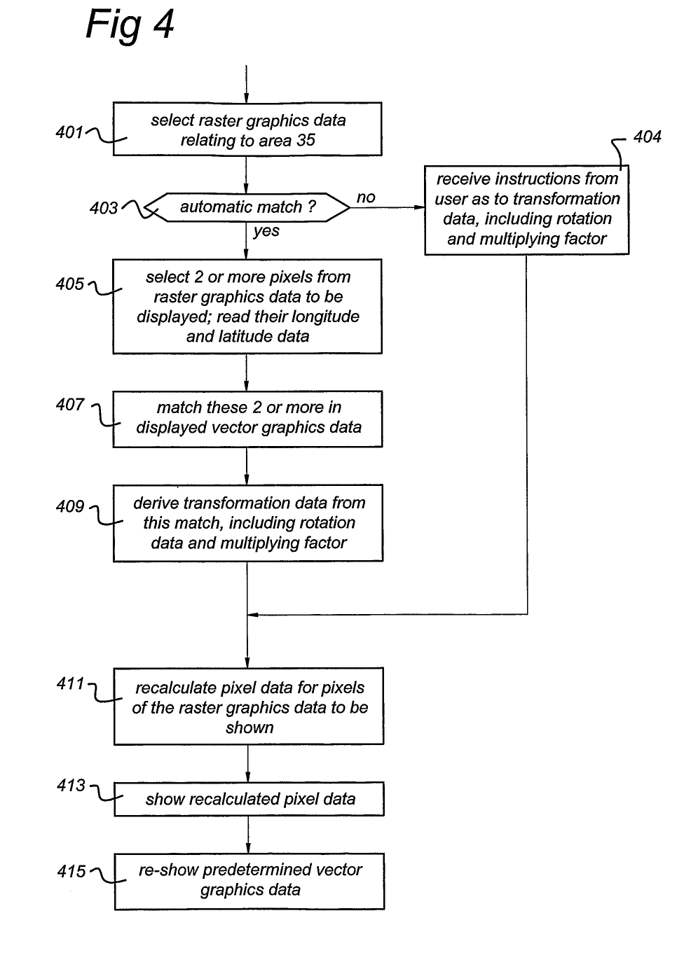

The area 35 has a plurality of pixels. At the top, there is a top left pixel with latitude and longitude co-ordinates (Tₓₗ, T_{yl}), a top right pixel with latitude and longitude co-ordinates (Tₓᵣ, T_{yr}), a bottom left pixel with latitude and longitude co-ordinates (Bₓₗ, B_{yl}), and a bottom right pixel with latitude and longitude co-ordinates (Bₓᵣ, B_{yr}). Some or all of these latitude and longitude coordinates (Tₓₗ, T_{yl}), (Tₓᵣ, T_{yr}), (Bₓₗ, B_{yl}), (Bₓᵣ, B_{yr}) are stored together with the pixels they relate to. The navigation system is programmed to automatically map the area 35 into the map shown on the display 3, as will be explained with reference to FIG. 4.

FIG. 4 shows a flow chart of an example of operation of the navigation system in accordance with a program stored in memory 5-11. The flow chart assumes that vector graphics data is already shown on display 3 in an area outside area 35. The program begins in action 401 with selecting raster graphics data relating to area 35. This selection may be based on instructions received from a user instructing the navigation system to search for such raster graphics data. The raster graphics data may already be stored in memory, e.g., hard disk 5, but it is also possible to download such raster graphics data in real-time such that it is temporarily stored in RAM 11. In action 403, the program checks whether it can make an automatic match. This can only be done if the raster graphics data received comprises suitable latitude and longitude data. If, in action 403, the system establishes that it can make an automatic match it jumps to action 405. If not, it jumps to action 404.

In action 405, the processor 1 determines the latitude and longitude co-ordinates of at least 2 pixels of the received raster graphics data and, in action 407, matches these 2 pixels with two locations on the display 3. Generally, latitude and longitude data from 2 pixels is sufficient to calculate a match. Data from more pixels may result in conflicts but may be needed for non-linear matches. From this match, in action 409, the processor 1 derives transformation data for the raster graphics data necessary to transform these raster graphics data into a picture that can be shown in area 35 and that is aligned with the data that is surrounding area 35. These transformation data may include rotation data and a multiplying factor. In order to match the raster graphics data, the number of pixels thereof may, e.g., need be reduced by a factor of e.g. 100 (i.e., a multiplying factor of 1/100). Then, the display data (e.g. colour) of any pixel of the picture to be shown will be calculated by the processor 1 as an average based on pixel data of an original pixel and, e.g., 100 of its surrounding original pixels. If the number of pixels of the raster graphics data is less than the number of pixels on the display 3, then, pixel data for the pixels between the original pixels need be calculated by the processor 1, e.g., by calculating interpolated pixel data. The recalculation action is shown in action 411. In action 413, the resulting bit map is shown in area 35. After step 413, the vector graphics based data is not shown anymore in area 35. However, in most cases one wishes to see at least the roads of the vector graphics based data in area 35. Therefore, optionally, in action 415, predetermined portions of the vector graphics data are re-shown in area 35, like the roads 33. These vector graphics based data may completely either cover the raster graphics data in area 35 or may be transparently shown.

Optionally, in action 411, the processor 1 checks whether the resulting bit map comprises pixel data that exceeds a predetermined first level of accuracy relating to a level of density of information and remains below a predetermined second level of accuracy which is higher than the first accuracy level. If it does not exceed this first accuracy level, the user will not be able to distinguish any useful data in area 35 on display 3 anymore. If it exceeds the second accuracy level there will be too much detail to distinguish useful data. Moreover, in the latter case the system may become too slow. Then, a message may be shown on the display 3 informing the user to that effect and the resulting bit map is not shown.

If, in action 403, the system had established that it could not make an automatic match it had jumped to action 404, as explained above. In action 404, the processor 1 waits until it has received instructions from the user regarding rotation and multiplication to be made on the raster graphics data before it is shown to the user in area 35 on display 3. The program continues with action 411, and recalculates the pixel data based on the input from the user as received in action 404. In action 413, the processor 1 shows the recalculated data. Optionally, action 415 follows action 413. Thus, the user can determine the scale on which the raster graphics data is shown. The user may himself/herself rotate and scale the raster graphics data such that it is aligned with the vector graphics data of the map surrounding area 35. However, he may, optionally, choose to see some details on an enlarged scale.

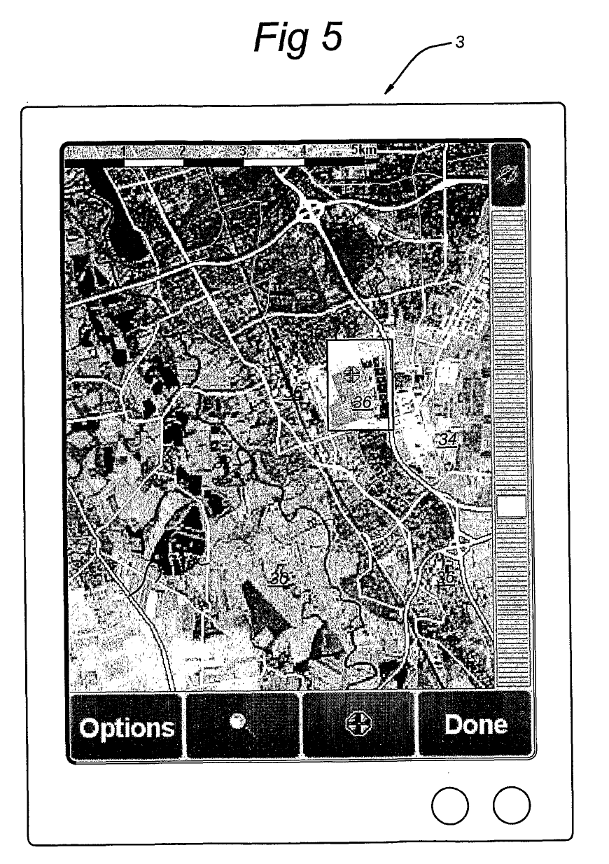

FIG. 5 shown an example of the result of the method as explained with reference to FIG. 4. The program running on the navigation system has instructed the processor 1 to show the following:
1. to show at least a set of all roads 33 from the vector graphics data within the area of interest;
2. to show pixels of a bitmap comprising a photo of the area outside these roads 33 and outside area 35;
3. to show pixels of a bitmap comprising a detailed map of an exhibition area within area 35.
   In the display of FIG. 5, all geographic data of all types of data sets (vector graphics and raster graphics) are aligned with each other as to latitude and longitude. In practice, this would mean that all selected roads 33 are always shown on display 3, whereas in other areas the photo of the whole area is shown apart from area 35 where the map of the exhibition area is shown.

Optionally, before showing data to the user via display 3, the processor 1 may further transform the data to be displayed into a perspective display. Such a transformation into perspective display is known to persons skilled in the art and needs no further explanation here. Instead of a “real” perspective display a semi-perspective (or other) display may be performed, e.g., via a z-buffer or other transformation on the original data.

The system as explained above offers several advantages:
1. when the raster graphics data as stored or downloaded relates to aerial or satellite photos the pixel data eventually shown is derived from real coloured data which is attractive to people using the system. Moreover, people may then be able to orient themselves easier, because they may use e.g. photographic images of rivers, woods, footpaths in the wood, etc. Moreover the GPS system may still show where one is even if one is outside one of the roads 33 meaning that the navigation system itself cannot calculate a route at that moment;
2. the raster graphics data may relate to more detailed data of area 35 than can be stored on a CD-ROM for a map of, e.g., a whole country. Thus, a user may store such more detailed data for areas 35 of interest in memory 5-11, e.g., relating to walking areas or cycling areas, walking paths on a large exhibition area or an amusement park, rivers, lakes, sea, etc. Detailed data as to such areas is normally missing on CD-ROMs with navigation data. Such detailed raster graphics data can be bought from Internet companies;
3. raster graphics data can be downloaded real-time. E.g., one can download real-time raster graphics data from a server where people share storing and retrieving images or from a satellite, relating to a certain area where one wishes to walk and look to the weather conditions at that moment. Alternatively, one may download real-time satellite pictures of a parking area near an amusement park, or near the beach, or of a traffic-jam on one or more roads. So, based on real-time conditions of a specific area 35 one may be in a better position to take a decision as to how to travel to a certain destination location;
4. the raster graphics data may be based on (digital) pictures taken by a user himself or herself, e.g., a picture of the centre of Paris taken from the Eiffel tower. The only thing the user has to do is to add latitude and longitude data to the picture as stored, or manually align this picture on display 3.

It is observed that the map displayed on display 3 in FIG. 2 is shown to display the position of the navigation system by means of arrow 37. However, optionally, it is possible to allow the user to select a portion of a map not including the position of the navigation system itself.

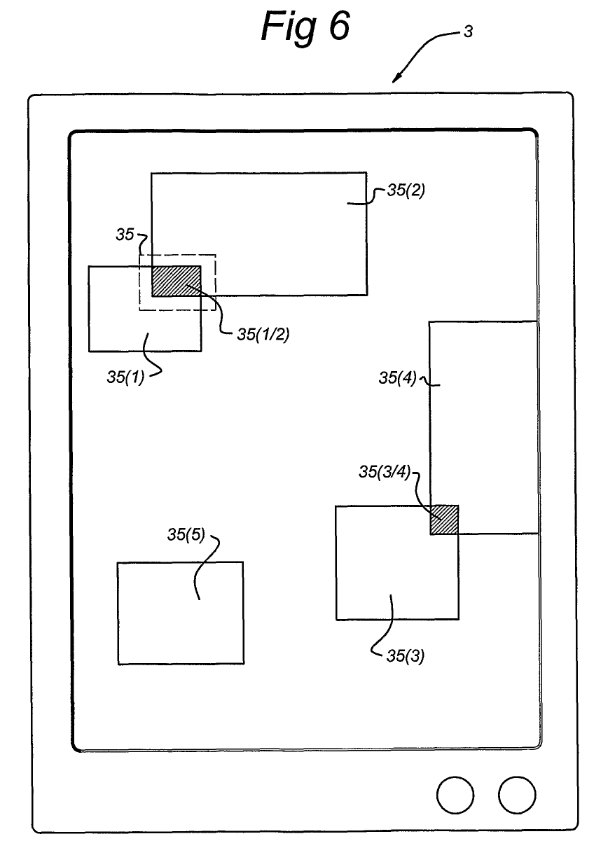

In an embodiment, the memory 5-11 may be storing a plurality of raster graphics based pictures. These pictures may have overlapping areas as already explained with reference to FIG. 5. This is further explained with reference to FIG. 6, where pictures only partially overlap.

FIG. 6 shows display 3 and a plurality of areas 35(i), where i=1, 2, . . . . For each of these areas 35(i), memory 5-11 stores different raster graphics based pictures, e.g., satellite photos, photographs, images. In this example, it is assumed that the information density of the raster graphics based pictures as to the different areas 35(i) differ. Here information density is defined as number of square meters (m²) in an area represented by a bit map divided by number of pixels in that bitmap. Moreover, some of the pictures relate to overlapping areas. Pictures relating to areas 35(1) and 35(2) are shown to have an overlapping area 35(1/2). Pictures relating to areas 35(3) and 35(4) are shown to have an overlapping area 35(3/4). A picture relating to area 35(5) is shown to have no overlap with any other picture in memory 5-11.

FIG. 6 also shows that a user has indicated that he/she wishes to have the display 3 show more detailed information about an area 35 that includes a part of area 35(1), overlapping area 35(1/2), part of area 35(2) and, e.g., roads of the vector graphics data within the whole display 3. The processor 1 will select the raster graphics data with the highest density, e.g., in a way as explained below.

First of all, each time the navigation system receives new raster graphics pictures the processor 1 derives from the pictures received the latitude and longitude (or coordinate) data to which these pictures relate, as well as an indication of the pixel density. These pictures are stored in dependence on these latitude and longitude (coordinate) data.

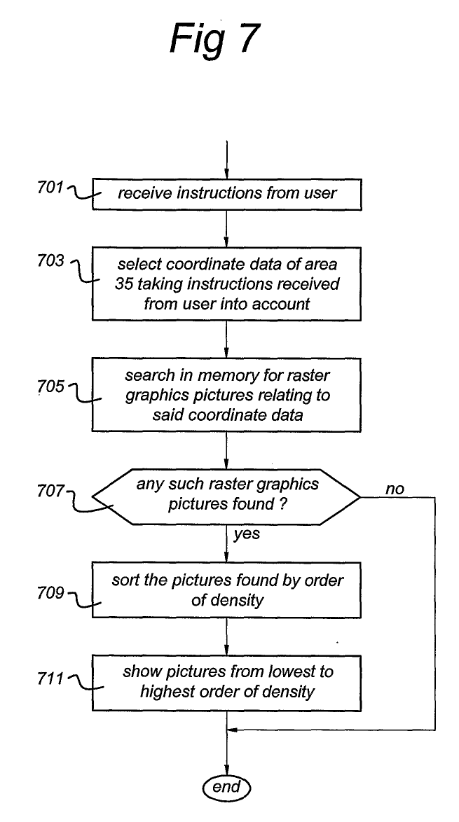

Secondly, if the navigation system receives instructions from a user to integrate raster graphics data into vector graphics data shown on the display 3 the processor 1 may perform the actions as shown in FIG. 7.

In action 701, the processor 1 receives instructions from a user as to integrate raster graphics data in area 35.

In action 703, the processor 1 selects coordinate data of area 35 taking instructions received from the user into account.

In action 705, the processor 1 searches in its memory 5-11 for raster graphics pictures relating to area 35.

In action 707, the processor 1 checks whether any such raster graphics pictures are found. If yes, it continues with action 709. If no, it jumps to the end of the program.

In action 709, the processor 1 sorts all found pictures by order of density.

In action 711, the processor 1 shows the found pictures from lowest to highest order of density in area 35 on display 3. This means that where for a specific pixel raster graphics data is available from several orders of density, at the end only the raster graphics data of the highest order of density is shown (those data of lower orders of density are overwritten). In semi-programming language this may look like:

draw a picture X

for each pixel P within area 35 on display 3, set the colour of pixel P to colour C, where C is determined as follows:
determine the coordinate L represented by pixel P by interpolation within the coordinate data of area 35;
then, C is the colour of a picture pixel p1 in some picture X such that
   picture X contains coordinate L, and
   no other picture Y exists that contains coordinate L and has a higher density than picture X, and
   no other picture pixel p2 in the picture X represents a coordinate closer to coordinate L than picture pixel p1.

It is observed that e.g. a hard disk 5 can store a tremendous amount of raster graphics data. Thus, many pictures can be stored in hard disk 5. Most of these pictures may relate to areas outside the area of interest to the user at a certain moment in time. By receiving latitude and longitude information for area 35 from the user, the processor 1 can easily search for any available raster graphics data for area 35. To that end, the processor may use any known search algorithm, e.g., a binary search algorithm when the raster graphics data has been stored in the order of latitude and longitude data.

As to including height information in the display shown, the following is observed. It is possible that stored vector graphics data includes height data that is used on the display 3, e.g., to produce a perspective display. Still it is possible to integrate 2D data from raster graphics data into such display. Alternatively, the vector graphics data may only relate to 2D data whereas the raster graphics data may relate to 3D bitmap data. However, also then it is possible to integrate these data, i.e., e.g., by showing the 3D bitmap data in area 35 either as 3D data in a perspective view or as 2D data derived from the 3D data.

Within an area where both vector graphics data and raster graphics data are shown, they may be shown with different brightness or such that one of those data types is shown in a transparent way and one sees the other data through that one data type.

1. Navigation system comprising a processors, a memory and a displays, the processor being arranged to communicate with the memory and the displays, the memory storing instructions and data to allow said processor to run a program, the processor being arranged to receive vector graphics data relating to a map of a first geographic area corresponding to a portion of the earth surface and to show first data relating to said vector graphics data on said display and to calculate a route based on received user instructions, the processor also being arranged to receive raster graphics data relating to a second geographic area, and to show second data relating to said raster graphics data on top of said first data in an area on said display, which second data is aligned as to latitude and longitude with said first data on the display if latitude and longitude data to that effect is available.

2. Navigation system according to claim 1, wherein said second geographic data is more detailed than said first geographic data.

3. Navigation system according to claim 1, wherein said processor is arranged to re-show predetermined portions of said first data on top of said second data.

4. Navigation system according to claim 1, wherein at least one of said vector graphics data and raster graphics data comprise height information.

5. Navigation system according to claim 1, wherein said processor is arranged to show said second data only when it comprises pixel data above a predetermined first density level and below a predetermined second density level, said second level being higher than said first level.

6. Navigation system according to claim 1, wherein said processor is arranged to display at least one of said first and second data in a perspective view.

7. Navigation system according to claim 1, wherein said system is arranged to download said raster graphics data from an external source.

8. Navigation system according to claim 7, wherein said system is arranged to continuously download raster graphics data based pictures of areas surrounding the location of the navigation system itself.

9. Navigation system according to claim 7, wherein said raster graphics data includes real-time photographic data.

10. Navigation system according to claim 1, wherein said processor is connected to a location sensor and is arranged to determine a location of said navigation system based on data received from said location sensor, and to show said location on said display.

11. Navigation system according to claim 10, wherein said processor is arranged to calculate said route for a user of said navigation system based on starting position data and destination position data.

12. Navigation system according to claim 1, wherein said memory stores multiple portions of raster graphics data and said processor is arranged to select one or more of said portions on predetermined criteria, and to transform said selected one or more of said portions into said second data.

13. Navigation system according to claim 12, wherein said multiple portions comprise at least two portions relating to an overlapping geographic area.

14. Navigation system according to claim 13, wherein said criterion is based on pixel density per earth surface area.

15. Navigation system according to claim 14, wherein said memory stores said multiple portions in an order depending on latitude and longitude information.

16. Navigation system according to claim 1, wherein the processor is arranged to receive transformation instructions from a user so as to rotate and scale the second data on the display if the second data does not comprise suitable latitude and longitude data.

17. Method of receiving vector graphics data relating to a map of a first geographic area corresponding to a portion of the earth surface and to show first data relating to said vector graphics data on a display and to calculate a route based on received user instructions, the method also comprising receiving raster graphics data relating to a second geographic area, and to show second data relating to said raster graphics data on top of said first data in an area on said display, which second data is aligned as to latitude and longitude with said first data on the display if latitude and longitude data to that effect is available.

18. Computer program product comprising instructions and data to allow a processor to run a predetermined program in accordance with the method claimed in claim 17.

19. Data carrier comprising a computer program product according to claim 18.
